(19) United States
(12) Patent Application Publication
(10) Pub. No.: US 2026/0300905 A1
(43) Pub. Date: Oct. 1, 2026

(54) DYNAMIC SUPPLY CHAIN OPTIMIZATION FRAMEWORK

(71) Applicant: Dell Products L.P., Round Rock, TX (US)

(72) Inventor: Pankaj Pande, Carlingford (AU)

(21) Appl. No.: 19/093,717

(22) Filed: Mar. 28, 2025

(51) Int. Cl. G06Q 10/087; G06Q 10/0631

(52) U.S. Cl. CPC G06Q 10/087; G06Q 10/0631

(57) ABSTRACT

A method for generating a supply chain topology includes receiving real-time data from a supply chain and verifying that the real-time data is from a trusted source to obtain verified real-time data. Additionally, the method includes generating a finalized supply chain topology using the verified real-time data, where the generating includes identifying nodes and edges within the supply chain using the verified real-time data, mapping the nodes and the edges to obtain the supply chain topology, and allocating supply chain resources using the verified real-time data and the supply chain topology to obtain a finalized supply chain topology. Further the method includes presenting, by a visualization and reporting module, the finalized supply chain topology to a user.

### BACKGROUND

Supply chains are intricate systems composed of numerous interconnected nodes and edges. Data continuously propagates between these components influencing the operation and performance of the supply chains. Supply chain topologies are often used for monitoring and managing supply chains. However, generating accurate and responsive supply chain topologies remains a complex task due to the dynamic and ever-evolving nature of modern supply chains.

### BRIEF DESCRIPTION OF DRAWINGS

Certain embodiments of the disclosure will now be described with reference to the accompanying drawings. However, the accompanying drawings illustrate only certain aspects or implementations of the disclosure by way of example and are not meant to limit the scope of the claims.

FIG. 1 shows a diagram of a system in accordance with one or more embodiments.

FIG. 2 shows a diagram of a dynamic supply chain system in accordance with one or more embodiments.

FIG. 3 shows a flowchart of a method for making changes to a supply chain in accordance with one or more embodiments.

FIG. 4 shows a flowchart of a method for generating a supply chain topology in accordance with one or more embodiments.

FIG. 5 shows a flowchart of a method for allocating resources in a supply chain in accordance with one or more embodiments.

FIG. 6 shows a flowchart of a method for making changes to a supply chain using an adaptive learning algorithm (ALA) module in accordance with one or more embodiments.

FIG. 7 shows a flowchart of a method for generating predictive insights for a supply chain in accordance with one or more embodiments.

FIG. 8 shows a diagram of a computing system in accordance with one or more embodiments.

### DETAILED DESCRIPTION

In today's fast-paced and increasingly globalized marketplaces, managing supply chains effectively poses a significant challenge. Traditional supply chain management methodologies struggle to handle dynamic, real-time data, leading to inefficiencies and delays that can have substantial financial and operational repercussions. Current systems often rely on static models that lack the adaptability required to accommodate fluctuating conditions and evolving requirements. This rigidity can result in suboptimal resource allocation, inefficient logistical operations, and a lack of predictive capabilities necessary for proactive management.

Moreover, the inability to provide transparent and explainable insights into the decision-making process further compounds these challenges. Stakeholders increasingly demand verifiable and understandable systems that not only predict outcomes but also elucidate the rationale behind strategic decisions. The lack of such explainability in conventional systems undermines trust and calls for more advanced solutions capable of addressing these needs.

Another critical limitation of contemporary solutions is their inability to handle complex data topologies effectively. Traditional data analysis techniques often miss subtle patterns and connections within the extensive and intricate datasets that characterize global supply chains. This oversight can lead to missed opportunities for efficiency improvements and risk mitigation.

These challenges are significant because supply chain inefficiencies and delays can cascade through an entire organization, leading to increased operational costs, missed deadlines, and unsatisfied customers. As the market continues to evolve, the pressure to enhance supply chain performance intensifies, necessitating innovative approaches that leverage modern data processing and analysis techniques.

In light of the issues discussed above, the disclosure provides a system for optimizing supply chain management that integrates multiple advanced methodologies to address inefficiencies and streamline operations. At its core, the solution combines a real-time data processing (RTDP) module, an efficient verification and query acceleration (EVeCA) module, an adaptive learning algorithm (ALA) module, a topological data analysis (TDA) module, a material and process planning (MPP) module, a predictive insights module, and a visualization and reporting module, all contributing to a robust and dynamic decision-making process. The system begins by using the RTDP module to collect real-time data from various points in the supply chain. This data is fed into the EVeCA module which verifies the real-time data through efficient verifiable data queries to maintain the integrity and trustworthiness of the gathered data. The verified real-time data is fed to the TDA module, which maps the supply chain, visualizing complex patterns and identifying key nodes and edges. The MPP module ensures that resources are distributed fairly across these nodes using the resource allocation methodologies, maintaining equitable and stable operations. As the system processes the verified real-time data, the ALA module iteratively makes changes to the supply chain, to continuously improve the supply chain based on evolving conditions. These changes pertain to resource allocation, shipping routes, and inventory management. The predictive insights module leverages historical supply chain data and the verified real-time data to offer foresight into potential future trends, enabling proactive management. The visualization and reporting module provides stakeholders with transparent, real-time visual updates and reports, facilitating informed decision-making. Together, these modules create a cohesive system that enhances supply chain efficiency by ensuring data accuracy, optimizing logistical decisions in real time, and providing clear, actionable insights.

Specific embodiments will now be described with reference to the accompanying figures.

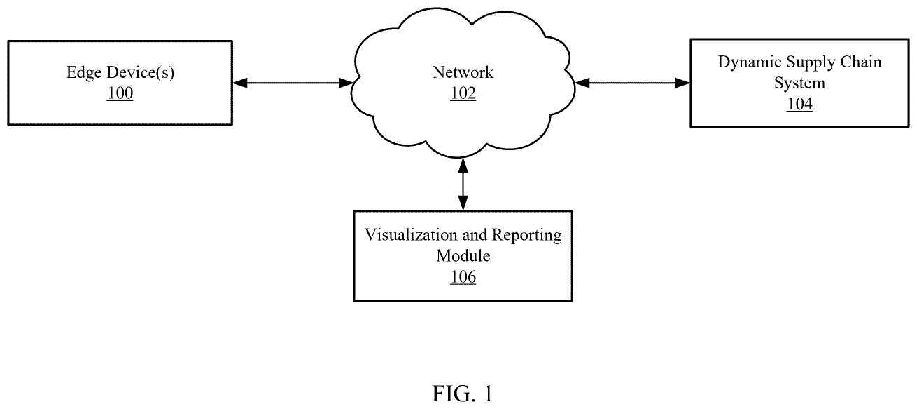

FIG. 1 shows a system in accordance with one or more embodiments. The system may include an edge device(s) (100), a network (102), a dynamic supply chain system (104), and a visualization and reporting module (106). The system may include additional, fewer, and/or different components without departing from the scope of the embodiments disclosed herein. Each component may be operably/operatively connected to any of the other components via any combination of wired and/or wireless connections. Each of these system components is described below.

In one or more embodiments, the edge device(s) (100), the dynamic supply chain system (104), and the visualization and reporting module (106) may be operatively connected to one another through the network (102) (e.g., a local area network (LAN), a wide area network (WAN) such as the Internet, a mobile network, any other network type, or a combination thereof). Further, the network (102) may encompass various interconnected, network-enabled subcomponents (or systems) (e.g., switches, routers, gateways, etc.) that may facilitate communications between the aforementioned components. Moreover, the edge device(s) (100), the dynamic supply chain system (104), and the visualization and reporting module (106) may communicate with one another using any combination of wired and/or wireless communication protocols.

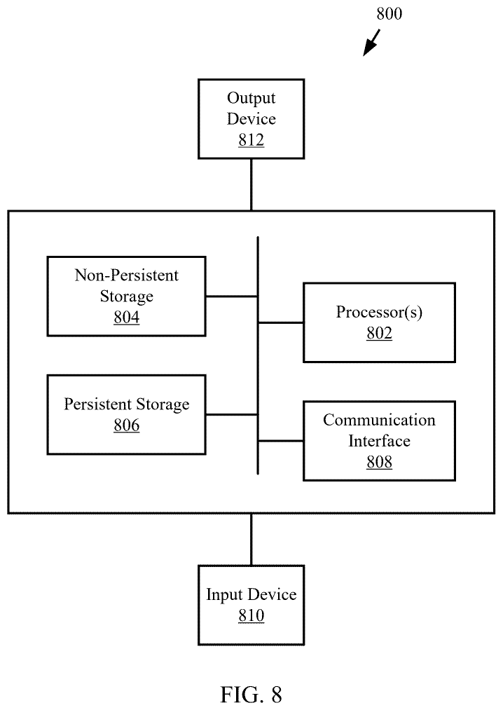

In one or more embodiments, the edge device(s) (100) may be a physical device such as a personal computing system (e.g., a laptop, a cell phone, a tablet computer, a server, etc.) configured for hosting one or more workloads, or for providing a computing environment whereon workloads may be implemented. For example, the edge device(s) (100) may be a computing system (e.g., 800, FIG. 8) as discussed below in more detail in FIG. 8. In one or more embodiments, the edge device(s) (100) may include a user interface (e.g., a graphical user interface) (not shown) that allows a user to interact with applications running on the edge device(s) (100).

In one or more embodiments, the edge device(s) (100) may include any number of applications (and/or content accessible through the applications) that provide computer-implemented services to a user. In one or more embodiments, the applications may include but should not be limited to, word processing applications, spreadsheet applications, email applications/clients, database applications, presentation applications, calendar applications, etc. Applications may be designed and configured to perform one or more functions instantiated by a user of the edge device(s) (100). In order to provide application services, each application may host similar or different components. The components may be, for example (but not limited to), instances of databases, instances of email servers, etc. Applications may be executed on one or more edge device(s) (100) as instances of the application.

Applications may vary in different embodiments, but in certain embodiments, applications may be custom-developed or commercial (e.g., off-the-shelf) applications that a user desires to execute on the edge device(s) (100). In one or more embodiments, applications may be logical entities executed using computing resources of the edge device(s) (100). For example, applications may be implemented as computer instructions stored on persistent storage of the edge device(s) (100) that when executed by the processor(s) of the edge device(s) (100), cause the edge device(s) (100) to provide the functionality of the applications described throughout the application.

In one or more embodiments, while performing, for example, one or more operations requested by a user, applications installed on the edge device(s) (100) may include functionality to request and use physical and logical resources of the edge device(s) (100). Applications may also include functionality to use data stored in storage/memory resources of the edge device(s) (100). The applications may perform other types of functionalities not listed above without departing from the scope of the embodiments disclosed herein. While providing application services to a user, applications may store data that may be relevant to the user in storage/memory resources of the edge device(s) (100).

In one or more embodiments, to provide services to the users, the edge device(s) (100) may utilize, rely on, or otherwise cooperate with an infrastructure node (IN) (not shown). For example, the edge device(s) (100) may issue requests to the IN to receive responses and interact with various components of the IN. The edge device(s) (100) may also request data from and/or send data to the IN (for example, the edge device(s) (100) may transmit information to the IN that allows the IN to perform computations, the results of which are used by the edge device(s) (100) to provide services to the users). As yet another example, the edge device(s) (100) may utilize computer-implemented services provided by the IN. When the edge device(s) (100) interacts with the IN, data that is relevant to the edge device(s) (100) may be stored (temporarily or permanently) in the IN.

In one or more embodiments, the edge device(s) (100) may be capable of, for example: (i) collecting users'inputs, (ii) correlating collected users'inputs to the computer-implemented services to be provided to the users, (iii) communicating with INs that perform computations necessary to provide the computer-implemented services, (iv) using the computations performed by the infrastructure nodes to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IN (using any known protocol in the art), for example, to exchange remote desktop traffic or any other regular protocol traffic (so that, once authenticated, users may remotely access independent VDs).

As described above, the edge device(s) (100) may provide computer-implemented services to users (and/or other computing devices). The edge device(s) (100) may provide any number and any type of computer-implemented services. To provide computer-implemented services, an edge device(s) (100) may include a collection of physical components (e.g., processing resources, storage/memory resources, networking resources, etc.) configured to perform operations of the edge device(s) (100) and/or otherwise execute a collection of logical components (e.g., virtualization resources) of the edge device(s) (100).

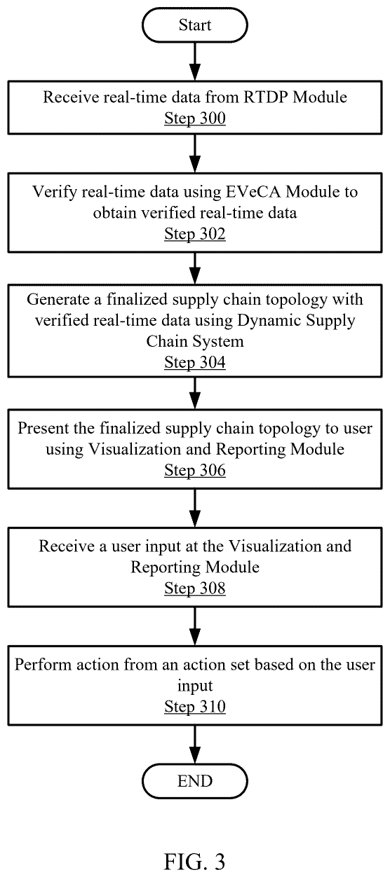

Further, the edge device(s) (100) may include functionality to perform at least a portion of the methods shown in FIGS. 3-7. One of ordinary skill in the art will appreciate that the edge device(s) (100) may perform other functionalities without departing from the scope of the embodiments disclosed herein.

In one or more embodiments, the dynamic supply chain system (104) includes the functionality to process supply chain data (i.e., information related to the storage, movement, and processing of goods, materials, and services within a supply chain) to generate predictive insights and supply chain topologies as discussed below in FIGS. 3-7. In one or more embodiments, a supply chain topology refers to a structured layout of nodes and edges in a supply chain, illustrating how resources (e.g., goods, information, finances, etc.) flow between the nodes in the supply chain. In one or more embodiments, a supply chain refers to a network of nodes and edges through which resources flow from suppliers to end customers. In one or more embodiments, a node refers to any point within the supply chain where resources are collected, processed, stored, or transferred, such as suppliers, warehouses, distribution centers, retail locations, etc. In one or more embodiments, an edge refers to a link or a pathway that facilitates the movement or exchange of resources between nodes, such as transport routes, communication channels, data interfaces, etc. In one or more embodiments, the predictive insights include information to support proactive decision-making related to inventory management, transportation routes, and resource allocation, including but not limited to forecasts of supply chain demand, future supply chain topologies, identification of potential disruptions, optimization recommendations for routing and resource management, risk assessments, etc. Further, the dynamic supply chain system (104) may include functionality to perform at least a portion of the methods shown in FIGS. 3-7. One of ordinary skill in the art will appreciate that the dynamic supply chain system (104) may perform other functionalities without departing from the scope of the embodiments disclosed herein.

In one or more embodiments, the visualization and reporting module (106) includes the functionality to present predictive insights and supply chain topologies from the dynamic supply chain system (104) to users. In one or more embodiments, the visualization and reporting module (106) includes the functionality to compile the predictive insights and the supply chain topologies into a comprehensive format that allows users to make proactive and informed decisions about the supply chain. In one or more embodiments, the visualization and reporting module (106) presents the comprehensive format to the users via a graphical user interface (GUI). Further, the visualization and reporting module (106) may include functionality to perform at least a portion of the methods shown in FIGS. 3-7. One of ordinary skill in the art will appreciate that the visualization and reporting module (106) may perform other functionalities without departing from the scope of the embodiments disclosed herein.

In one or more embodiments, the edge device(s) (100), the dynamic supply chain system (104), and the visualization and reporting module (106) are each implemented as a computing device (e.g., 800, FIG. 8). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid-state drives, etc.). The computing device may include instructions, stored on the persistent storage, that when executed by the processor(s) of the computing device cause the computing device to perform the functionality of the edge device(s) (100), the dynamic supply chain system (104), and the visualization and reporting module (106) described throughout this application.

In one or more embodiments, the edge device(s) (100), the dynamic supply chain system (104), and the visualization and reporting module (106) are each implemented as a logical device. The logical device may utilize the computing resources of any number of computing devices and thereby provide the functionality of the edge device(s) (100), the dynamic supply chain system (104), and the visualization and reporting module (106).

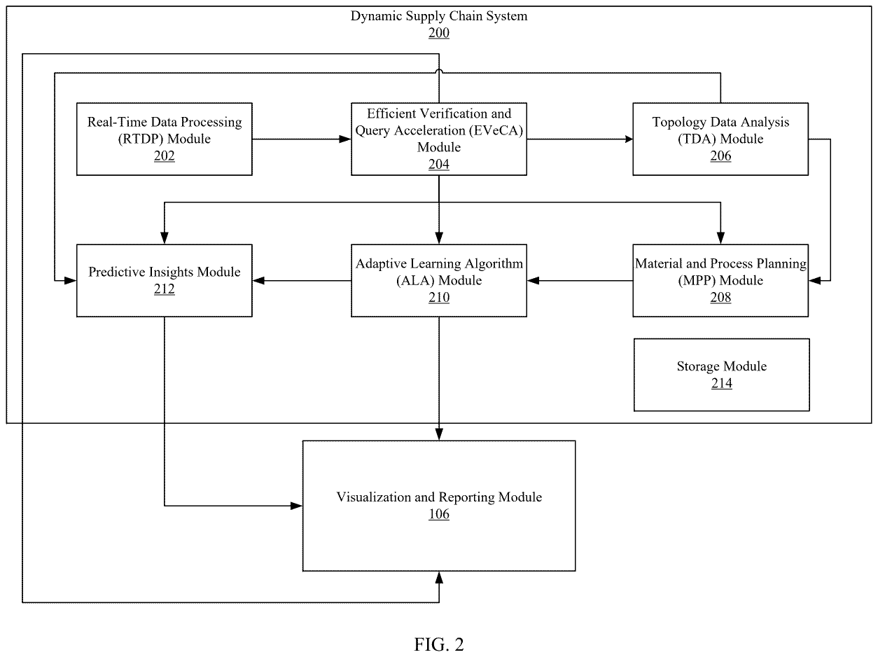

Turning to FIG. 2, FIG. 2 shows a diagram of a dynamic supply chain system (200) in accordance with one or more embodiments. The dynamic supply chain system (200) may include a real-time data processing (RTDP) module (202), an efficient verification and query acceleration (EVeCA) module (204), a topology data analysis (TDA) module (206), a material and process planning (MPP) module (208), an adaptive learning algorithm (ALA) module (210), a predictive insights module (212), and a storage module (214). The system may include additional, fewer, and/or different components without departing from the scope of the embodiments disclosed herein. Each component may be operably/operatively connected to any of the other components via any combination of wired and/or wireless connections. Each of these system components is described below.

In one or more embodiments, the RTDP module (202) includes the functionality to obtain and process real-time data from the supply chain. In one or more embodiments, real-time data refers to data that is collected, transmitted, and made available for immediate processing and analysis as actions, changes, or conditions occur within the supply chain, including but not limited to: inventory level fluctuations, shipment departures and arrivals, order placements and confirmations, production status updates, equipment performance metrics, supplier notifications, customer delivery confirmations etc. In one or more embodiments, a supply chain refers to a network of nodes and edges through which resources (e.g., goods, information, finances, etc.) flow from suppliers to end customers. In one or more embodiments, a node refers to any point within the supply chain where resources are collected, processed, stored, or transferred, such as suppliers, warehouses, distribution centers, retail locations, etc. In one or more embodiments, an edge refers to a link or a pathway that facilitates the movement or exchange of resources between nodes, such as transport routes, communication channels, data interfaces, etc. In one or more embodiments, the RTDP module continuously collects data from multiple sources within the supply chain including but not limited to, IoT sensors, RFID tags, GPS devices, transactional systems, etc. In one or more embodiments, the RTDP module uses an event-driven architecture to process the real-time data as it collects it. In one or more embodiments, event-driven architecture refers to real-time data being collected and processed immediately in response to specific events within the supply chain including but not limited to a shipment reaching its destination, a sale being made, a shipment being delayed, etc. Further, the RTDP module (202) may include functionality to perform at least a portion of the methods shown in FIGS. 3-7. One of ordinary skill in the art will appreciate that the RTDP module (202) may perform other functionalities without departing from the scope of the embodiments disclosed herein.

In one or more embodiments, the EVeCA module (204) includes the functionality to verify the real-time data. In one or more embodiments, the EVeCA module utilizes a challenged-based authentication mechanism wherein upon receiving real-time data from the RTDP module, the EVeCA module generates a challenge that the RTDP module must respond to with a verification key including but not limited to a cryptographic key, a pre-shared key, authentication token, etc., to verify the real-time data. For example, in one or more embodiments, the EVeCA module (204) verifies data using a blockchain-based technology. In one or more embodiments, once the EVeCA module (204) verifies the real-time data, it sends it to the TDA module (206), the MPP module (208), the ALA module (210), and the predictive insights module (212). Further, the EVeCA module (204) may include functionality to perform at least a portion of the methods shown in FIGS. 3-7. One of ordinary skill in the art will appreciate that the EVeCA module (204) may perform other functionalities without departing from the scope of the embodiments disclosed herein.

In one or more embodiments, the TDA module (206) includes the functionality to map all of the nodes and edges within a supply chain to obtain a supply chain topology. In one or more embodiments, a supply chain topology refers to a structured layout of nodes and edges in a supply chain, illustrating how resources flow between the nodes in the supply chain. In one or more embodiments, the TDA module (206) utilizes TDA libraries (i.e., a toolset that uses mathematical and geometric techniques to identify, visualize, and analyze complex patterns, relationships, and anomalies within supply chains). In one or more embodiments, the TDA module (206) utilizes TDA libraries to analyze complex data patterns within the supply chain to assist in mapping the nodes and edges. Further, the TDA module (206) may include functionality to perform at least a portion of the methods shown in FIGS. 3-7. One of ordinary skill in the art will appreciate that the TDA module (206) may perform other functionalities without departing from the scope of the embodiments disclosed herein.

In one or more embodiments, the MPP module (208) includes the functionality to allocate resources amongst the nodes in a supply chain. In one or more embodiments, the MPP module (208) uses an resource allocation methodology, such as the Museum Pass Problem, to allocate the resources in the supply chain. In one or more embodiments, the Museum Pass Problem refers to a method for fairly allocating limited resources over time to multiple nodes within the supply chain, where each node has different preferences or availabilities, in a manner that ensures equitable access based on each node's needs and opportunities to utilize the resources. Further, the MPP module (208) may include functionality to perform at least a portion of the methods shown in FIGS. 3-7. One of ordinary skill in the art will appreciate that the MPP module (208) may perform other functionalities without departing from the scope of the embodiments disclosed herein.

In one or more embodiments, the ALA module (210) includes the functionality to make changes to the supply chain using machine learning to obtain updated supply chain topologies. In one or more embodiments, the ALA module (210) continuously makes changes to the supply chain as it receives verified real-time data from the EVeCA module (204). In one or more embodiments, the ALA module (210) employs machine learning frameworks (e.g., TensorFlow™, PyTorch™, etc.) and reinforcement learning techniques (e.g., Q-Learning, Policy Gradient Methods, etc.), to continuously adapt its decision-making processes using the verified real-time data. In one or more embodiments, this allows the ALA module (210) to make dynamic changes to the supply chain based on the verified real-time data. In one or more embodiments, reinforced learning techniques refer to machine learning methods where an agent learns to make decisions by performing actions and receiving rewards and penalties based on the actions. Further, the ALA module (210) may include functionality to perform at least a portion of the methods shown in FIGS. 3-7. One of ordinary skill in the art will appreciate that the ALA module (210) may perform other functionalities without departing from the scope of the embodiments disclosed herein.

In one or more embodiments, the predictive insights module (212) includes the functionality to generate predictive insights about the supply chain using historical supply chain data. In one or more embodiments, the predictive insights include information to support proactive decision-making related to inventory management, transportation routes, and resource allocation, including but not limited to forecasts of supply chain demand, future supply chain topologies, identification of potential disruptions, optimization recommendations for routing and resource management, risk assessments, etc. Further, the predictive insights module (212) may include functionality to perform at least a portion of the methods shown in FIGS. 3-7. One of ordinary skill in the art will appreciate that the predictive insights module (212) may perform other functionalities without departing from the scope of the embodiments disclosed herein.

In one or more embodiments, the storage module (214) includes the functionality to store data (e.g., historic supply chain data, past supply chain topologies, etc.). The storage module (214) may utilize volatile storage, non-volatile storage, or any combination thereof. Examples of storage include (but are not limited to): a hard disk drive (HDD), a solid-state drive (SSD), random access memory (RAM), flash memory, a tape drive, a fibre-channel (FC) based storage module, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, and virtualized memory. In one or more embodiments, the storage module (214) may be operably connected to the edge device(s) (e.g., 100 in FIG. 1). Further, the storage module (214) may include functionality to perform at least a portion of the methods shown in FIGS. 3-7. One of ordinary skill in the art will appreciate that the storage module (214) may perform other functionalities without departing from the scope of the embodiments disclosed herein.

In one or more embodiments, the RTDP module (202), the EVeCA module (204), the TDA module (206), the MPP module (208), the ALA module (210), the predictive insights module (212), and the storage module (214) are each implemented as a computing device (e.g., 800, FIG. 8). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid-state drives, etc.). The computing device may include instructions, stored on the persistent storage, that when executed by the processor(s) of the computing device cause the computing device to perform the functionality of the RTDP module (202), the EVeCA module (204), the TDA module (206), the MPP module (208), the ALA module (210), the predictive insights module (212), and the storage module (214) described throughout this application.

In one or more embodiments, the RTDP module (202), the EVeCA module (204), the TDA module (206), the MPP module (208), the ALA module (210), the predictive insights module (212), and the storage module (214), and the visualization and reporting module (106) each implemented as a logical device. The logical device may utilize the computing resources of any number of computing devices and thereby provide the functionality of the RTDP module (202), the EVeCA module (204), the TDA module (206), the MPP module (208), the ALA module (210), the predictive insights module (212), and the storage module (214).

Turning to FIG. 3, FIG. 3 shows a flowchart of a method for making changes to a supply chain in accordance with one or more embodiments disclosed herein. The method may be performed by, for example, a dynamic supply chain system (e.g., 104 in FIG. 1). Other components in the system may perform this method without departing from the scope of the disclosure.

While the various steps in the flowchart shown in FIG. 3 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 3 may be performed concurrently with one or more steps in FIGS. 3-7.

In step 300, the dynamic supply chain system receives real-time data from a real-time data processing (RTDP) module (e.g., 202 in FIG. 2). In one or more embodiments, real-time data refers to data that is collected, transmitted, and made available for immediate processing and analysis as actions, changes, or conditions occur within the supply chain, including but not limited to: inventory level fluctuations, shipment departures and arrivals, order placements and confirmations, production status updates, equipment performance metrics, supplier notifications, customer delivery confirmations etc. In one or more embodiments, a supply chain refers to a network of nodes and edges through which resources (e.g., goods, information, finances, etc.) flow from suppliers to end customers. In one or more embodiments, a node refers to any point within the supply chain where resources are collected, processed, stored, or transferred, such as suppliers, warehouses, distribution centers, retail locations, etc. In one or more embodiments, an edge refers to a link or a pathway that facilitates the movement or exchange of resources between nodes, such as transport routes, communication channels, data interfaces, etc. In one or more embodiments, the RTDP module continuously collects data from multiple sources within the supply chain including but not limited to, IoT sensors, RFID tags, GPS devices, transactional systems, etc. In one or more embodiments, the RTDP module uses an event-driven architecture to process the real-time data as it collects it. In one or more embodiments, event-driven architecture refers to real-time data being collected and processed immediately in response to specific events within the supply chain including but not limited to a shipment reaching its destination, a sale being made, a shipment being delayed, etc. In one or more embodiments, the event-driven architecture uses message brokers (i.e., a software system that acts as an intermediary, facilitating communication and data exchange between different applications, systems, or services (e.g., Apache Kafka™, Amazon Kinesis™, RabbitMQ™)). In one or more embodiments, the RTDP module categorizes data based on priority levels and relevance. In one or more embodiments, the RTDP module may prioritize sending data that is of higher priority and relevance including but not limited to data related to a delay of a large shipment, a large increase in sales, etc. In one or more embodiments, the priority and relevance of data are determined by a user. In one or more embodiments, the RTDP module utilizes cloud resources (i.e., computing services including: storage, processing power, databases, and networking, delivered over the internet (“the cloud”)) to enable scalability, allowing it to handle increasing volumes of data within the supply chain without compromising performance.

In step 302, the dynamic supply chain system verifies the real-time data using an efficient verification and query acceleration (EVeCA) module (e.g., 204 in FIG. 2) to obtain verified real-time data. In one or more embodiments, the EVeCA module utilizes a challenged-based authentication mechanism wherein upon receiving real-time data from the RTDP module, the EVeCA module generates a challenge that the RTDP module must respond to with a verification key including but not limited to a cryptographic key, a pre-shared key, authentication token, etc., to verify the real-time data. In one or more embodiments, the RTDP module uses an adaptive learning algorithm (ALA) module (e.g., 210 in FIG. 1) to adjust verification parameters based on current network conditions and threat intelligence. In one or more embodiments, the EVeCA module employs a distributed ledger (i.e., a decentralized database, such as a blockchain, managed across multiple nodes ensuring the secure transparent, and tamper-proof recording of data interactions) to securely enter all real-time data verifications. In one or more embodiments, the distributed ledger results in an immutable (i.e., unable to be changed, altered, or modified after creation) and transparent audit trail, ensuring that each data verification entry is verifiable, tamper-resistant, and trackable. It should be appreciated, that leveraging the distributed ledger in this manner provides secure proof that data verifications have occurred, prevents unauthorized changes, and ensures transparency across the system. It should be further appreciated, that the distributed ledger will allow for rapid and efficient lookups of previously verified data entries due to its transparent and immutable nature. In one or more embodiments, the EVeCA module continuously sends the verified real-time data to a topology data analysis (TDA) module (e.g., 206 in FIG. 2), a material and process planning (MPP) module (e.g., 208 in FIG. 2), an adaptive learning algorithm (ALA) module (e.g., 210 in FIG. 2), and a predictive insights module (e.g., 212 in FIG. 2) enabling optimal decision-making based on the most current and accurate information available. In one or more embodiments, the EVeCA module uses cryptographic techniques including but not limited to zero-knowledge proofs (i.e., a cryptographic method for verifying that a statement is true without revealing any underlying or additional information about the statement) to verify the real-time data. In one or more embodiments, the EVeCA module uses Zero-Knowledge Succinct Non-Interactive Arguments of Knowledge (zk-SNARKs) libraries to create and validate the zero-knowledge proofs. It should be appreciated, that the zk-SNARKs libraries enable rapid and efficient generation and verification of zero-knowledge proofs, ensuring data authenticity and integrity without exposing sensitive information.

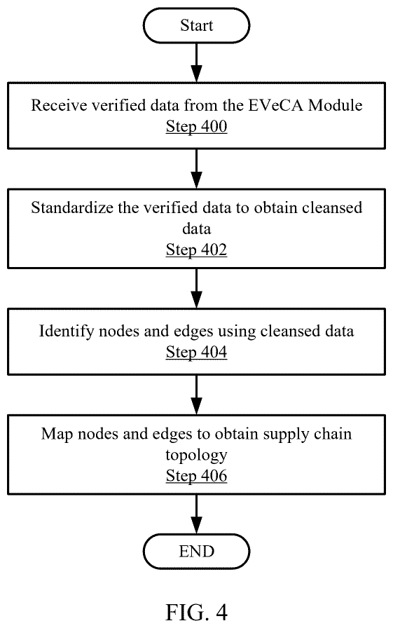

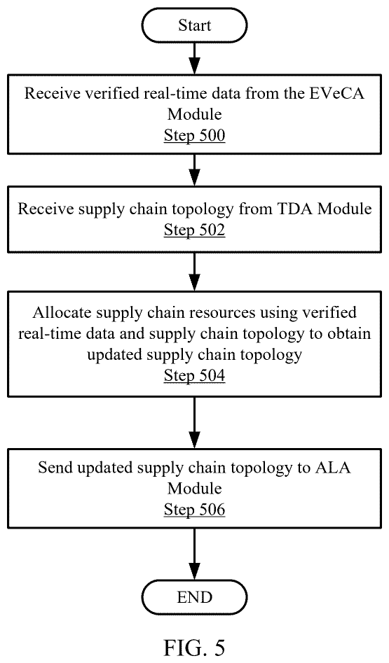

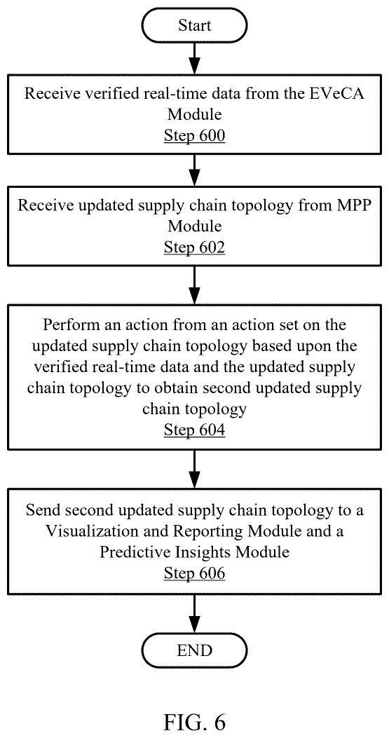

In step 304, the dynamic supply chain system generates a finalized supply chain topology. In one or more embodiments, a supply chain topology refers to a structured layout of nodes and edges in a supply chain, illustrating how resources (e.g., goods, information, finances, etc.) flow between the nodes in the supply chain. In one or more embodiments, the finalized supply chain topology is generated using the verified real-time data, the TDA module to generate a supply chain topology as discussed below in FIG. 4, the MPP module to equitably allocate the supply chain resources to obtain an updated supply chain topology as discussed below in FIG. 5, and the ALA module to make real-time changes to the supply chain to obtain a second updated supply chain topology (i.e., the final supply chain topology) as discussed below in FIG. 6. In one or more embodiments, the final supply chain topology may be generated by any means known in the art or discovered in the future.

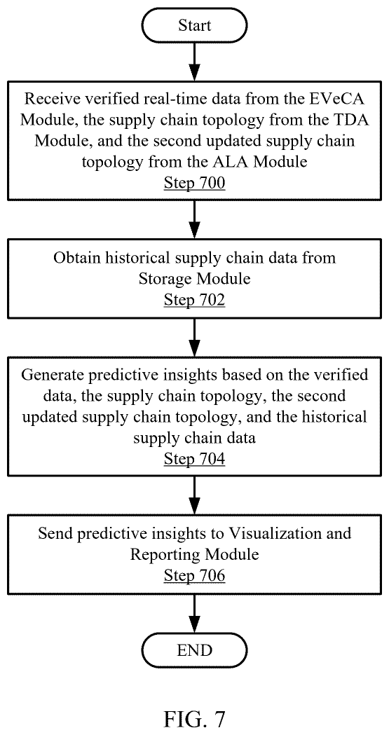

In step 306, the dynamic supply chain system via the ALA module presents the finalized supply chain topology to a user using a visualization and reporting module (e.g., 106 in FIG. 1). In one or more embodiments, in addition to receiving the finalized supply chain topology, the visualization and reporting module receives predictive insights from the predictive insights module as discussed below in FIG. 7. In one or more embodiments, the predictive insights include information to support proactive decision-related inventory management, transportation routes, and resource allocation, including but not limited to forecasts of supply chain demand, future supply chain topologies, identification of potential disruptions, optimization recommendations for routing and resource management, and risk assessments. In one or more embodiments, the dynamic supply chain system presents the finalized supply chain topology along with the predictive insights to the user using the visualization and reporting module. In one or more embodiments, the visualization and reporting module receives a supply chain topology from the TDA module as discussed below in FIG. 4. In one or more embodiments, the visualization and reporting module presented the user with the supply chain topology. In one or more embodiments, the visualization and reporting module receives an updated supply chain topology from the MPP module, as discussed below in FIG. 5. In one or more embodiments, the visualization and reporting module presents the updated supply chain topology to the user. In one or more embodiments, the visualization and reporting module receives verified real-time data from the EVeCA module. In one or more embodiments, the visualization and reporting module presents the verified real-time to the user. In one or more embodiments, the visualization and reporting module continuously receives data from all of the above-mentioned modules. In one or more embodiments, the visualization and reporting module combines the verified real-time data, the supply chain topology, the updated supply chain topology, the finalized supply chain topology, and the predive insights in a comprehensive format to provide users with the most up-to-date and accurate visualizations of the supply chain. In one or more embodiments, the data in the comprehensive format includes but is not limited to supply chain topologies, predictive insights, real-time data, etc. It should be appreciated, that this results in enhanced transparency within the supply chain allowing users to make informed decisions, promoting fair and efficient logistics management. In one or more embodiments, the visualization and reporting module presents the comprehensive format to the user using visualization libraries (i.e., a software tool used to create a visual representation of data) including but not limited to D3.js™ and Plotly™. In one or more embodiments, the visualization libraries provide a framework that supports dynamic data visualization and facilitates real-time updates to the supply chain. In one or more embodiments, the visualization and reporting module includes a graphical user interface (GUI). In one or more embodiments, the GUI is built using modern front-end frameworks including but not limited to React™, Angular™, etc. In one or more embodiments, the GUI allows the user to explore different scenarios within the supply chain. In one or more embodiments, the visualization and reporting module presents the comprehensive format to the user using the GUI. In one or more embodiments, the dynamic supply chain system continuously monitors for anomalies within the supply chain. In one or more embodiments the dynamic supply chain system searches the finalized supply chain topology for anomalies. In one or more embodiments, when the dynamic supply chain system detects an anomaly, it sends the anomaly to the visualization and reporting module. A non-limiting example of an anomaly is an abnormally large order from a retailer at 3:00 am in the morning.

In step 308, the visualization and reporting module receives user input in response to the final supply chain topology and the predictive insights. In one or more embodiments, the user input is also based upon at least one of: the supply chain topology, the updated supply chain topology, the verified real-time data, and an anomaly. In one or more embodiments, the user input includes but should not be limited to instructions such as adding or removing one or more nodes from the supply chain, adding or removing one or more edges in the supply chain, allocating resources to or deallocating resources from a node in the supply chain, etc. In one or more embodiments, the user input includes natural language text, computer-readable code, or a combination thereof. In one or more embodiments, the user enters their input into the GUI of the visualization and reporting module. In one or more embodiments, the visualization and reporting module uses a natural language processing (NLP) model to process the user input. In one or more embodiments, the NLP model may be any NLP model known in the art or discovered in the future.

In step 310, the dynamic supply chain system performs an action corresponding to the user input. In one or more embodiments, the action is from an action set including but not limited to: allocating more resources to a node in the supply chain, deallocating resources from a node in the supply chain, changing edges in the supply chain, adding or removing an edge in the supply chain, etc. In a non-limiting example, if the user input includes instructions to remove Node 39, the dynamic supply chain system will remove Node 29 from the supply chain. In one or more embodiments, if the dynamic supply chain system determines that the corresponding action exceeds an importance threshold, it sends a confirmation message to a user through GUI before proceeding with the action. In one or more embodiments, the importance threshold may be determined by any means known in the art or discovered in the future including but not limited to: impact an action has on the supply chain, cost of the action, difficulty of performing the action, etc.

In one or more embodiments, the method ends following step 310.

Turning to FIG. 4, FIG. 4 shows a flowchart of a method for generating a supply chain topology in accordance with one or more embodiments disclosed herein. The method may be performed by, for example, a topology data analysis (TDA) module (e.g., 206 in FIG. 2). Other components in the system may perform this method without departing from the scope of the disclosure.

While the various steps in the flowchart shown in FIG. 4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 4 may be performed concurrently with one or more steps in FIGS. 3-7.

In step 400, the TDA module receives verified real-time data from an efficient verification and query acceleration (EVeCA) module (e.g., 204 in FIG. 2). In one or more embodiments, the verified real-time data is the same verified real-time data as in FIG. 3. In one or more embodiments, the verified real-time data is received from the EVeCA module continuously.

In step 402, the TDA module standardizes the verified real-time data to obtain cleansed data. In one or more embodiments, standardizing data means transforming data from various sources into a consistent, uniform format, ensuring all data points are represented in the same way, allowing for easier analysis and comparison across different datasets by following predefined rules regarding formatting, naming conventions, and categorization. In one or more embodiments, the TDA module may use any method known in the art or discovered in the future to standardize the verified real-time data. In one or more embodiments, in addition to standardizing the verified real-time data, the TDA module also sanitizes the data. In one or more embodiments, sanitizing the verified real-time data refers to removing inconsistencies or duplicates within the verified real-time. In one or more embodiments, the TDA module may use any method known in the art or discovered in the future to sanitize the verified real-time data.

In step 404, the TDA module identifies all of the nodes and edges within the supply chain using the cleansed data. In one or more embodiments, a node refers to any point within the supply chain where resources (e.g., goods, information, finances, etc.) are collected, processed, stored, or transferred, such as suppliers, warehouses, distribution centers, retail locations, etc. In one or more embodiments, an edge refers to a link or a pathway that facilitates the movement or exchange of resources between nodes, such as transport routes, communication channels, data interfaces, etc. In one or more embodiments, a supply chain refers to a network of nodes and edges through which resources flow from suppliers to end customers. In one or more embodiments, the TDA module may identify the nodes and edges by any means known in the art or discovered in the future.

In step 406, the TDA module maps all of the nodes and the edges to obtain a supply chain topology. In one or more embodiments, a supply chain topology refers to a structured layout of nodes and edges in a supply chain, illustrating how resources (e.g., goods, information, finances, etc.) flow between the nodes in the supply chain. In one or more embodiments, the TDA module utilizes TDA libraries (i.e., a toolset that uses mathematical and geometric techniques to identify, visualize, and analyze complex patterns, relationships, and anomalies within supply chains), including but not limited to Giotto-tda™, Ripser™, GUDHI™, etc. In one or more embodiments, the TDA module utilizes TDA libraries to analyze complex data patterns within the supply chain to assist in mapping the nodes and edges. In one or more embodiments, the TDA libraries identify key nodes (i.e., critical points within the supply chain that have a significant impact on its efficiency and performance, including but not limited to major suppliers, central manufacturing hubs, high-volume distribution centers, etc.) and key edges (i.e., edges that allow the flow of resources between key nodes). In one or more embodiments, the TDA module uses the key nodes and the key edges to obtain a more comprehensive supply chain topology. In one or more embodiments, the TDA module uses persistent homology algorithms (i.e., algorithms that analyze qualitative features of data that persist across multiple scales (i.e., different levels of connectivity or proximity used to analyze the structure of data)) to assess the complexity of the supply chain, identify bottlenecks between nodes in the supply chain, and identify isolated nodes in the supply chain.

In one or more embodiments, the TDA module calculates Betti numbers corresponding to: the complexity of the supply chain (B0), bottlenecks between nodes in the supply chain (B2), and isolated nodes in the supply chain (B3). In one or more embodiments, the TDA module may calculate the Betti numbers by any means known in the art or discovered in the future. In one or more embodiments, if the TDA module identifies that one or more of the Betti numbers are above a threshold, the TDA module flags the corresponding part of the supply chain. In one or more embodiments, the threshold is determined by a user. In one or more embodiments, the threshold is determined by any means known in the art. In one or more embodiments, the Betti numbers are updated as the TDA module receives the verified real-time data. In one or more embodiments, the TDA module includes the Betti numbers on the supply chain topology. In one or more embodiments, the TDA module may map the nodes and edges using any means known in the art or discovered in the future. In one or more embodiments, the TDA module sends the supply chain topology to a material and processing (MPP) module (e.g., 208 in FIG. 2). In one or more embodiments, the TDA module sends the supply chain topology to a storage module (e.g., 214 in FIG. 2). In one or more embodiments, the TDA module sends the supply chain topology to a predictive insights module (e.g., 212 in FIG. 2). In one or more embodiments, the TDA module sends the supply chain topology to the above modules by any means known in the art or discovered in the future.

In one or more embodiments, the method ends following step 406.

Turning to FIG. 5, FIG. 5 shows a flowchart of a method for allocating resources in a supply chain in accordance with one or more embodiments disclosed herein. The method may be performed by, for example, a material and process planning (MPP) module (e.g., 208 in FIG. 1). Other components in the system may perform this method without departing from the scope of the disclosure.

While the various steps in the flowchart shown in FIG. 5 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 5 may be performed concurrently with one or more steps in FIGS. 3-7.

In step 500, the MPP module (e.g., 208 in FIG. 2) receives verified real-time data from an efficient verification and query acceleration (EVeCA) module (e.g., 204 in FIG. 2). In one or more embodiments, the verified real-time data is the same verified real-time data as in FIG. 3. In one or more embodiments, the verified real-time data is received from the EVeCA module continuously.

In step 502, the MPP module (e.g., 208 in FIG. 2) receives a supply chain topology from a topology data analysis (TDA) module (206). In one or more embodiments, a supply chain topology refers to a structured layout of nodes and edges in a supply chain, illustrating how resources (e.g., goods, information, finances, etc.) flow between the nodes in the supply chain. In one or more embodiments, a supply chain refers to a network of nodes and edges through which resources flow from suppliers to end customers. In one or more embodiments, a node refers to any point within the supply chain where resources are collected, processed, stored, or transferred, such as suppliers, warehouses, distribution centers, retail locations, etc. In one or more embodiments, an edge refers to a link or a pathway that facilitates the movement or exchange of resources between nodes, such as transport routes, communication channels, data interfaces, etc. In one or more embodiments, the supply chain topology is the same supply chain topology as in FIG. 4.

In step 504, the MPP module allocates resources amongst the nodes in the supply chain using the verified real-time data and the supply chain topology to obtain an updated supply chain topology. In one or more embodiments, the MPP module uses the Museum Pass Problem to allocate the resources. In one or more embodiments, the Museum Pass Problem refers to a method for fairly allocating limited resources over time to multiple nodes within the supply chain, where each node has different preferences or availabilities, in a manner that ensures equitable access based on each node's needs and opportunities to utilize the resources. It should be appreciated, that using the Museum Pass Problem methodology ensures that resources are distributed proportionally across various nodes of the supply chain, promoting fairness and stability. In one or more embodiments, the Museum Pass Problem can be modeled as a graph-based optimization problem, where nodes represent exhibits or locations, edges represent visitor pathways, and graph algorithms such as shortest path and number of floors are used to optimize resource movement and allocation amongst the nodes and edges in the supply chain. In one or more embodiments, python libraries including but not limited to, NetworkX™, igraph™, NetworKit™, etc., are used to construct and analyze the graph in the Museum Pass Problem. In one or more embodiments, the MPP module implements the Lloyd-Max quantization algorithm to distribute resources proportionally amongst the nodes in the supply chain. In one or more embodiments, the MPP module adjusts the resource allocation of the supply chain topology as it receives verified real-time data from the EVeCA module.

In step 506, the MPP module sends the updated supply chain topology to an adaptive learning algorithm module (ALA) (e.g., 210 in FIG. 1). In one or more embodiments, the MPP module sends the updated supply chain topology to a storage module (e.g., 214 in FIG. 2). In one or more embodiments, the MPP module sends the updated supply chain topology to a predictive insights module (e.g., 212 in FIG. 2). In one or more embodiments, the MPP module sends the updated supply chain topology to the above modules by any means known in the art or discovered in the future.

In one or more embodiments, the method ends following step 506.

Turning to FIG. 6, FIG. 6 shows a flowchart of a method for making changes to a supply chain using an adaptive learning algorithm (ALA) module (e.g., 210 in FIG. 2) in accordance with one or more embodiments disclosed herein. The method may be performed by, for example, the ALA module (e.g., 210 in FIG. 2). Other components in the system may perform this method without departing from the scope of the disclosure.

While the various steps in the flowchart shown in FIG. 6 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 6 may be performed concurrently with one or more steps in FIGS. 3-7.

In step 600, the ALA module receives verified real-time data from an efficient verification and query acceleration (EVeCA) module (e.g., 204 in FIG. 2). In one or more embodiments, the verified real-time data is the same verified real-time data as in FIG. 3. In one or more embodiments, the verified real-time data is received from the EVeCA module continuously.

In step 602, the ALA module receives an updated supply chain topology from a material and process planning (MPP) module (e.g., 208 in FIG. 1). In one or more embodiments, a supply chain topology refers to a structured layout of nodes and edges in a supply chain, illustrating how resources (e.g., goods, information, finances, etc.) flow between the nodes in the supply chain. In one or more embodiments, a supply chain refers to a network of nodes and edges through which resources (e.g., goods, information, finances, etc.) flow from suppliers to end customers. In one or more embodiments, a node refers to any point within the supply chain where resources are collected, processed, stored, or transferred, such as suppliers, warehouses, distribution centers, retail locations, etc. In one or more embodiments, an edge refers to a link or a pathway that facilitates the movement or exchange of resources between nodes, such as transport routes, communication channels, data interfaces, etc. In one or more embodiments, the updated supply chain topology is the same supply chain topology as in FIG. 5.

In step 604, the ALA module makes a change to the supply chain based on the verified real-time data and the updated supply chain topology to obtain a second updated supply chain topology. In one or more embodiments, the change includes performing an action from an action set. In one or more embodiments, the actions from the action set include but are not limited to: allocating more resources to a node of the supply chain, deallocating resources from a node of the supply chain, modifying an edge in the supply chain, adding or removing an edge in the supply chain, etc. In one or more embodiments, if the ALA module determines that an action exceeds an importance threshold, it sends a confirmation message to a user through a graphical user interface (GUI) before proceeding with the action. In one or more embodiments, the importance threshold may be determined by any means known in the art or discovered in the future including but not limited to impact an action has on the supply chain, cost of the action, difficulty of performing the action, etc. In one or more embodiments, the ALA module obtains historical supply chain data from a storage module (e.g., 214 in FIG. 2). In one or more embodiments, historical supply chain data includes but should not be limited to past supply chain topologies, success rates associated with the past supply chain topologies, performance metrics, risk assessments, delivery timelines, supplier reliability, demand fluctuations, cost analyzes, incident reports related to disruption and inefficacies within the supply chain, etc. In one or more embodiments, the ALA module uses the historical supply chain data in addition to the verified real-time data and the updated supply chain topology to determine what change to make to the supply chain. In one or more embodiments, the ALA module continuously processes and analyzes the verified real-time data from the EVeCA module to dynamically make changes to the supply chain. It should be appreciated, that the second updated supply chain topology will continuously change as the ALA module receives the verified real-time data. In one or more embodiments, the ALA module employs machine learning frameworks (e.g., TensorFlow™, PyTorch™, etc.) and reinforcement learning techniques (e.g., Q-Learning, Policy Gradient Methods, etc.)), to continuously adapt its decision-making processes based on the verified real-time data. In one or more embodiments, this allows the ALA module to make dynamic changes to the supply chain based on the verified real-time data. In one or more embodiments, reinforced learning techniques refer to machine learning methods where an agent learns to make decisions by performing actions and receiving rewards and penalties based on the actions. In one or more embodiments, the ALA uses a deep learning model (DLM) to determine what changes to make to the supply chain. In one or more embodiments, a DLM may be a machine learning and/or artificial intelligence paradigm (e.g., a neural network, a decision tree, a support vector machine, etc.). Any DLM may be defined through a set of parameters and/or hyper-parameters that may be optimized or tuned to assure the optimal performance of a function. A parameter may refer to a configuration variable that is internal to the DLM and whose value may be estimated from data. Examples of a parameter include, but are not limited to, the weights in a neural network, and the support vectors in a support vector machine. In contrast, a hyper-parameter may refer to a configuration variable that is external to the DLM and whose value may not be estimated from data. Examples of a hyper-parameter include, but are not limited to, the learning rate for training a neural network, and the soft margin cost function for a nonlinear support vector machine. Further, any DLM may be further defined through other architectural elements, which may vary depending on the paradigm based on which the DLM may be modeled.

In one or more embodiments, a DLM may be optimized through supervised learning. Supervised learning may refer to learning (or optimization) through the analysis of training examples and/or data. One of ordinary skill will appreciate that other learning methodologies (e.g., unsupervised learning) may be used to optimize a DLM without departing from the scope of the disclosure. Substantively, in one or more embodiments, a DLM may include functionality to: receive input data (e.g., verified real-time data, updated supply chain topologies, external data (i.e., data that is external to the supply chain that may affect the supply chain such as weather forecasts), historical supply chain data, etc.); process the input data using an optimized set of architectural element values; and produce output data (e.g., second updated supply chain topologies) based on the processing. It should be appreciated, that the ALA module continuously improves the supply chain's performance by adapting to evolving conditions. It should be further appreciated that this ensures that the overall supply chain remains efficient, cost-effective, and resilient to changes.

In step 606, the ALA module sends the second updated supply chain topology to a visualization and reporting module (e.g., 106 in FIG. 1). In one or more embodiments, the ALA module sends the second updated supply chain topology to a predictive insights module (e.g., 212 in FIG. 1). In one or more embodiments, the ALA module sends the second updated supply chain topology to the storage module. In one or more embodiments, the ALA module sends the second updated supply to the above modules by any means known in the art or discovered in the future.

In one or more embodiments, the method ends following step 606.

Turning to FIG. 7, FIG. 7 shows a flowchart of a method for generating predictive insights for a supply chain in accordance with one or more embodiments disclosed herein. The method may be performed by, for example, a predictive insights module (e.g., 212 in FIG. 2). Other components in the system may perform this method without departing from the scope of the disclosure.

While the various steps in the flowchart shown in FIG. 7 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 7 may be performed concurrently with one or more steps in FIGS. 3-7.

In step 700, the predictive insights module receives verified real-time data from an efficient verification and query acceleration (EVeCA) module (e.g., 204 in FIG. 2) module, a supply chain topology from a topology data analysis (TDA) module (e.g., 206 in FIG. 2), and a second updated supply chain topology from an adaptive learning algorithm (ALA) module (e.g., 210 in FIG. 1). In one or more embodiments, the verified real-time data is the same verified real-time data as in FIG. 3. In one or more embodiments, the supply chain topology is the same supply chain topology as in FIG. 4. In one or more embodiments, the second updated supply chain topology is the same second updated supply chain topology as in FIG. 6. In one or more embodiments, the predictive insights module receives verified real-time data from the EVeCA module continuously. It should be appreciated, that receiving the verified real-time data continuously will provide the predictive insights module with the most up-to-date data to make the most accurate predictive insights as discussed below in step 704.

In step 702, the predictive insights module obtains historical supply chain data from a storage module (e.g., 214 in FIG. 2). In one or more embodiments, historical supply chain data includes but should not be limited to past supply chain topologies, success rates associated with the past supply chain topologies, performance metrics, risk assessments, delivery timelines, supplier reliability, demand fluctuations, cost analyzes, incident reports related to disruption and inefficacies within the supply chain, etc.

In step 704, the predictive insights module generates predictive insights based on the verified real-time data, the supply chain topology, the second updated supply chain topology, and the historical supply chain data. In one or more embodiments, the predictive insights include information to support proactive decision-making related to inventory management, transportation routes, and resource allocation, including but not limited to forecasts of supply chain demand, future supply chain topologies, identification of potential disruptions, optimization recommendations for routing and resource management, risk assessments, etc. For example, the predictive insight may include re-routing transportation routes to avoid severe weather, increasing inventory at certain locations to accommodate for predicted shortages, etc. It should be appreciated, that the predictive insights module allows for an optimized supply chain. In one or more embodiments, the predictive insights module continually receives verified real-time data from various points in the supply chain.

In one or more embodiments, the predictive insights module incorporates time-series forecasting models such as autoregressive integrated moving average (ARIMA), Prophet™, Long Short-Term Memory (LSTM) networks, etc. to assist in generating predictive insights by analyzing the historical supply chain data and the verified real-time data, identifying patterns and trends, and forecasting future values or behaviors of the supply chain. In one or more embodiments, the model is any model suitable to generate predictive insights including but not limited to a deep learning model (DLM) as discussed above in FIG. 6. In one or more embodiments, the predictive insights module continuously creates predictive insights as it receives verified real-time data to allow for the most accurate proactive decision-making. It should be appreciated, that the predictive insights module will assist in uncovering hidden patterns that are missed by conventional supply chain analysis techniques. In one or more embodiments, the predictive insights are in the form of graphs, topologies, natural language text, computer-readable code, or a combination thereof. In one or more embodiments, the predictive insights module uses a natural language processing (NLP) model to convert the predictive insights into natural language text. In one or more embodiments, the NLP model is any NLP model known in the art or discovered in the future.

In step 706, the predictive insights module sends the predictive insights to a visualization and reporting module (e.g., 106 in FIG. 1). In one or more embodiments, the predictive insights module sends predictive insights in real time as it generates them. In one or more embodiments, the predictive insights module sends the predictive insights to a visualization and reporting module by any means known in the art or discovered in the future.

In one or more embodiments, the method ends following step 706.

Embodiments of the disclosure may be implemented using computing devices. Turning to FIG. 8, FIG. 8 shows a diagram of a computing device (800) in accordance with one or more embodiments. The computing device (800) may include one or more computer processor(s) (802), non-persistent storage (804) (e.g., volatile memory, such as random access memory (RAM), cache memory), persistent storage (806) (e.g., a hard disk, an optical drive such as a compact disk (CD) drive or digital versatile disk (DVD) drive, a flash memory, etc.), a communication interface (808) (e.g., Bluetooth interface, infrared interface, network interface, optical interface, etc.), input devices (810), output devices (812), and numerous other elements (not shown) and functionalities. Each of these components is described below.

In one embodiment, the computer processor(s) (802) may be an integrated circuit for processing instructions. For example, the computer processor(s) (802) may be one or more cores or micro-cores of a processor. The computing device (800) may also include one or more input devices (810), such as a touchscreen, access keyboard, mouse, microphone, touchpad, electronic pen, or any other type of input device. The communication interface (808) may include an integrated circuit for connecting the computing device (800) to a network (e.g., 102 in FIG. 1) (e.g., a local area network (LAN), a wide area network (WAN) such as the Internet, mobile network, or any other type of network) and/or to another device, such as another computing device.

In one embodiment, the computing device (800) may include one or more output devices (812), such as a screen (e.g., a liquid crystal display (LCD), a plasma display, touchscreen, cathode ray tube (CRT) monitor, projector, or other display device), a printer, external storage, or any other output device. One or more of the output devices (812) may be the same or different from the input devices (810). The input and output device(s) (810, 812) may be locally or remotely connected to the computer processor(s) (802), non-persistent storage (804), and persistent storage (806). Many diverse types of computing devices exist, and the aforementioned input and output device(s) (810, 812) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments of the disclosure above, numerous specific details are set forth in order to provide a more thorough understanding of one or more embodiments of the disclosure. However, it will be apparent to one of ordinary skill in the art that the one or more embodiments of the disclosure may be practiced without these specific details. In other instances, well-known features have not been described in detail to avoid unnecessarily complicating the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connection between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage module, a diskette, a tape, flash memory, physical memory, or any other physical computer readable storage medium. Specifically, the software instructions may correspond to computer readable program code that, when executed by a processor(s), is configured to perform one or more embodiments described herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims below.

What is claimed is:

1. A method for generating a supply chain topology, the method comprising:
receiving real-time data from a supply chain;
verifying that the real-time data is from a trusted source to obtain verified real-time data;
generating a finalized supply chain topology using the verified real-time data, wherein the generating comprises:
identifying nodes and edges within the supply chain using the verified real-time data;
mapping the nodes and the edges to obtain the supply chain topology; and
allocating supply chain resources using the verified real-time data and the supply chain topology to obtain a finalized supply chain topology; and
presenting, by a visualization and reporting module, the finalized supply chain topology to a user.

2. The method of claim 1, further comprising:
receiving, after presenting, a user input at the visualization and reporting module; and
performing, based on the user input, an action from an action set on the finalized supply chain topology to obtain a second finalized supply chain topology.

3. The method of claim 2, further comprising:
detecting an anomaly within the second finalized supply chain topology;
presenting, by the visualization and reporting module, the anomaly to the user;
making a determination to perform a second action from the action set on the second finalized supply chain topology;
performing, based on the determination, the second action on the second finalized supply chain topology to obtain a third finalized supply chain topology.

4. The method of claim 2, wherein the action set includes at least one of: allocating more resources to a node of the supply chain, deallocating resources from a node of the supply chain, or modifying a supply chain route of the supply chain.

5. The method of claim 1, wherein generating the finalized supply chain topology further comprises:
performing, by an adaptive learning model, an action from an action set on the finalized supply chain topology based on the verified real-time data and allocating to obtain a second finalized supply chain topology;
obtaining historical supply chain data; and
generating a third finalized supply chain topology using the second finalized supply chain topology and the historical supply chain data.

6. The method of claim 5, wherein verifying comprises verifying via a distributed ledger.

7. The method of claim 1, wherein the edges represent supply chain routes or resources allocated between nodes.

8. The method of claim 1, wherein the mapping is achieved using at least one of: persistent homology algorithms, real-time data for pattern detection, or Betti number computation.

9. A non-transitory computer readable medium (CRM) comprising computer readable program code, which when executed by a computer processor, enables the computer to perform a method for generating a supply chain topology, the method comprising:
receiving real-time data from a supply chain;
verifying that the real-time data is from a trusted source to obtain verified real-time data;
generating a finalized supply chain topology using the verified real-time data, wherein the generating comprises:
identifying nodes and edges within the supply chain using the verified real-time data;
mapping the nodes and the edges to obtain the supply chain topology; and
allocating supply chain resources using the verified real-time data and the supply chain topology to obtain a finalized supply chain topology; and
presenting, by a visualization and reporting module, the finalized supply chain topology to a user.

10. The non-transitory CRM of claim 9, further comprising:
receiving, after presenting, a user input at the visualization and reporting module; and
performing, based on the user input, an action from an action set on the finalized supply chain topology to obtain a second finalized supply chain topology.

11. The non-transitory CRM of claim 10, further comprising:
detecting an anomaly within the second finalized supply chain topology;
presenting, by the visualization and reporting module, the anomaly to the user;
making a determination to perform a second action from the action set on the second finalized supply chain topology;
performing, based on the determination, the second action on the second finalized supply chain topology to obtain a third finalized supply chain topology.

12. The non-transitory CRM of claim 10, wherein the action set include at least one of: allocating more resources to a node of the supply chain, deallocating resources from a node of the supply chain, or modifying a supply chain route of the supply chain.

13. The non-transitory CRM of claim 9, wherein generating the finalized supply chain topology further comprises:
performing, by an adaptive learning model, an action from an action set on the finalized supply chain topology based on the verified real-time data and allocating to obtain a second finalized supply chain topology;
obtaining historical supply chain data; and
generating a third finalized supply chain topology using the second finalized supply chain topology and the historical supply chain data.

14. The non-transitory CRM of claim 13, wherein verifying comprises verifying via a distributed ledger.

15. The non-transitory CRM of claim 9, wherein the edges represent supply chain routes or resources allocated between nodes.

16. The non-transitory CRM of claim 9, wherein the mapping is achieved using at least one of:
persistent homology algorithms, real-time data for pattern detection, or Betti number computation.

17. A system for generating a supply chain topology, the system comprising:
persistent storage; and
a computing device, comprising a processor and memory, programmed to:
receive real-time data from a supply chain;
verify that the real-time data is from a trusted source to obtain verified real-time data;
generate a finalized supply chain topology using the verified real-time data, wherein the generating comprises:
identify nodes and edges within the supply chain using the verified real-time data;
map the nodes and the edges to obtain the supply chain topology; and
allocate supply chain resources using the verified real-time data and the supply chain topology to obtain a finalized supply chain topology; and
present, by a visualization and reporting module, the finalized supply chain topology to a user.

18. The system of claim 17, wherein the computing device is further programmed to:
receive, after presenting, a user input at the visualization and reporting module; and
perform, based on the user input, an action from an action set on the finalized supply chain topology to obtain a second finalized supply chain topology.

19. The system of claim 18, wherein the computing device is further programmed to:
detect an anomaly within the second finalized supply chain topology;
present, by the visualization and reporting module, the anomaly to the user;
make a determination to perform a second action from the action set on the second finalized supply chain topology;
perform, based on the determination, the second action on the second finalized supply chain topology to obtain a third finalized supply chain topology.

20. The system of claim 18, wherein the action set include at least one of: allocating more resources to a node of the supply chain, deallocating resources from a node of the supply chain, or modifying a supply chain route of the supply chain.
